(19) United States
(12) Patent Application Publication
(10) Pub. No.: US 2011/0290464 A1
(43) Pub. Date: Dec. 1, 2011

(54) HEADER FOR HEAT EXCHANGER AND METHOD OF MAKING THE SAME

(75) Inventors: Tracy MABES, Tulsa, OK (US); Ben COLE, Catoosa, OK (US); Alan GURKA, Owasso, OK (US); Charles BOWERS, Claremore, OK (US); Chris HOFFMAN, Owasso, OK (US); Brian WEAVER, Bristow, OK (US)

(73) Assignee: HARSCO CORPORATION, Camp Hill, PA (US)

(21) Appl. No.: 12/789,485

(22) Filed: May 28, 2010

(51) Int. Cl. F28F 9/02; B23P 15/26

(52) U.S. Cl. 165/173; 29/890.052

(57) ABSTRACT

A header box for a heat exchanger assembly and the method of manufacture. The header box has a first header component and a second header component. The first header component has a first corner portion with a first wall and a second wall extending therefrom. The second header component has a second corner portion with a third wall and a fourth wall extending therefrom. Free ends of the first wall and the third wall cooperate to form a first seam which is welded to maintain the first wall in position relative to the second wall. The free ends of the second wall and the fourth wall cooperate to form a second seam which is welded to maintain the third wall in position relative to the fourth wall. The header box, with the first corner portion and the second corner portion, will withstand the stress concentrations associated with a flow of fluid in the header box.

### FIELD OF THE INVENTION

The invention relates to headers for air-cooled heat exchangers and, more specifically, to a header having a generally square or rectangular body which is reliable and reduces manufacturing costs.

### BACKGROUND OF THE INVENTION

Air-cooled heat exchangers are frequently used in industrial applications. A fluid, either a gas or a liquid, is passed through a series of cooling tubes while air is mechanically passed over the exterior of the cooling tubes. The air absorbs heat from the cooling tubes, thereby lowering the temperature of the fluid within the tubes. The cooling tubes may include lateral or axial fins to aid in heat transfer.

Heat exchangers typically include two header boxes having the cooling tubes extending therebetween. The header boxes are formed from a hollow body, each of which has a plurality of ports which allow fluid communication with the cooling tubes. One header box is connected to an inlet coupling and, typically, the other header box is connected to an outlet coupling. Within the body, pass plates may be disposed between groups of cooling tubes ports so that a fluid entering the first header through the inlet conduit must follow a serpentine path, back and forth through the cooling tubes between the headers, to reach the outlet coupling.

Headers have many common cross-sectional shapes, for example, a quadrilateral, that is rectangular or square, round, oval or even obround. There are problems with header boxes of existing art. A quadrilateral header is typically formed by welding four individual flat plates together. Each of the seams between the plates must be welded. These long corner welds result in significant fabrication time and expense. In addition, these welds may fail, either in use or in testing prior to use. Because a quadrilateral header has generally right angle corners at the welds, the header is subject to stress concentrations which are localized along the welds. Thus, because stress concentrations contribute to potential failure of the header, it is preferable to reduce the number of welds and replace them with unwelded, curved surfaces in pressure vessels.

A header having a circular, oval, or obround cross-section does not have large stress concentrations like those described with respect to the quadrilateral header. A circular or oval header does, however, have other problems. For example, the cooling tubes are typically parallel to each another. Thus, when drilling cooling tube openings in a circular or oval header, the drill bit must be maintained in single plane, regardless of where on the perimeter the drill is located. Maintaining the alignment of the drill makes drilling difficult at the top and bottom of a circular or oval header. Similarly, it is more difficult to attach cooling tubes to a curved surface than it is to attach the cooling tubes to a flat surface.

Another problem in circular or oval headers is that, where threaded flat head shoulder plugs are used to plug access holes, the flat underside of the plug head does not fully engage the curved surface of the header. Thus, to provide an adequate sealing surface, the header may require spot face machining to provide flat surface for the plug to engage. Machining the header reduces the minimum thickness of the header wall in the area of the plug. Thus, the entire header may have to be manufactured with an additional material thickness to contain a specified pressure.

The invention of the obround header solved some, but not all, of these problems and has its own disadvantages. An obround header has a unitary body with two flat opposing vertical sides which are connected by two curved opposing sides. The openings for the cooling tubes and plugs are located on the two flat sides. Thus, the drilling of the openings for the cooling tubes and the plug is simplified and the cooling tubes and plugs are more easily coupled to the header. Because the header is made from a unitary body, there are no weld seams except at the ends where end plates are attached. The inlet coupling and outlet coupling, however, must still be coupled to one of the curved sides. The coupling must be specially formed to match the curved sides, and attaching the coupling to the curved side is difficult. Additionally, the obround shape makes installation of the pass plates more difficult. Also, because the curved sides extend above and below the plane of the cooling tubes, the obround header requires more space than a traditional quadrilateral header.

U.S. Pat. No. 6,523,260 discloses a header box with a hollow unitary body having four generally flat sides forming a generally quadrilateral cross-section. End plates are located at, and coupled to, each end of the unitary body. One generally flat side has a plurality of plug openings. The flat side opposite the one generally flat side with the plug openings includes a plurality of tube openings. Because the header is made from a unitary body, there are no weld seams except at the ends where end plates are attached. While this header box has no welds, the equipment needed to form the header box is specialized and not readily available, making the header box expensive and difficult to manufacture.

There is, therefore, a need for a header for a heat exchanger which has a quadrilateral cross-sectional profile and which has one set of opposing, flat sides having openings therethrough which are structured to be coupled to either cooling tubes or plugs, and a second set of opposing, flat sides having openings therethrough that are structured to be coupled to an inlet coupling or an outlet coupling. There is a further need for the header to be stable and easily manufacturable to facilitate connection to the other components of the heat exchanger.

### SUMMARY OF THE INVENTION

These needs, and others, are satisfied by the invention, which provides a method of making a header box for a heat exchanger assembly. The method includes the steps of: forming a first header component with a first integral corner; forming a second header component with a second integral corner; positioning the first header component proximate the second header component such that both ends of the first header component are positioned proximate respective ends of the second header component; and welding the ends of the first header component to the ends of the second header component to form a header box. The header box, with the first integral corner and the second integral corner, will withstand the stress concentrations associated with a flow of fluid in the header box.

The method may include the additional steps of: determining the position of the first integral corner and the second integral corner; and positioning the first integral corner and the second integral corner in a location in which maximum corner stress concentrations associated with the flow of fluid in the header box will occur. This reduces stresses associated with the ends of the first header component which are welded to the ends of the second header component.

Another aspect of the invention is directed to method of making a header box for a heat exchanger assembly. The method includes forming a pair of identical header components, with each of the first and second header components being formed into an L-shape. Each of the first and second headers also has a bent corner positioned between two sidewalls, with the sidewalls having free ends which extend away from the bent corner. The method also includes positioning the first header component proximate the second header component, with the second header component rotated approximately 180 degrees relative to the first header component. The free ends of the first header component are positioned proximate the free ends of the second header component. The method includes the additional step of welding the free ends of the first header component to the free ends of the second header component to form a header box. The header box, with the first integral corner and the second integral corner, will withstand the stress concentrations associated with a flow of fluid in the header box.

Another aspect of the invention is directed to a header box for a heat exchanger assembly. The header box has a first header component and a second header component. The first header component has a first corner portion with a first wall and a second wall extending therefrom. The first and second walls have free ends which extend away from the first corner portion. The first wall extends in a direction which is essentially perpendicular to the second wall. The second header component has a second corner portion with a third wall and a fourth wall extending therefrom. The third and fourth walls have free ends which extend away from the second corner portion. The third wall extends in a direction which is essentially perpendicular to the fourth wall. The first corner and the second corner are positioned in opposed corners of the header box. The free ends of the first wall and the third wall cooperate to form a first seam which is welded to maintain the first wall in position relative to the second wall. The free ends of the second wall and the fourth wall cooperate to form a second seam which is welded to maintain the third wall in position relative to the fourth wall. The header box, with the first corner portion and the second corner portion, will withstand the stress concentrations associated with a flow of fluid in the header box.

The header box and the method of manufacture of the header components reduce the labor and cost associated with the manufacture of the header assemblies when compared to the prior art. In addition, the bent, rounded corners of the header components provide strength in areas of high stress concentrations, increasing the stability and reliability of the header assembly.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is an isometric view of a heat exchanger assembly with two header boxes.

FIG. 2 is a cross-sectional view of a respective header box of the heat exchanger assembly of FIG. 1.

FIG. 3 is a side view of the respective header box of FIG. 2.

FIG. 4 is a schematic diagram of the manufacturing steps for assembling the header boxes of FIG. 1.

### DETAILED DESCRIPTION OF THE INVENTION

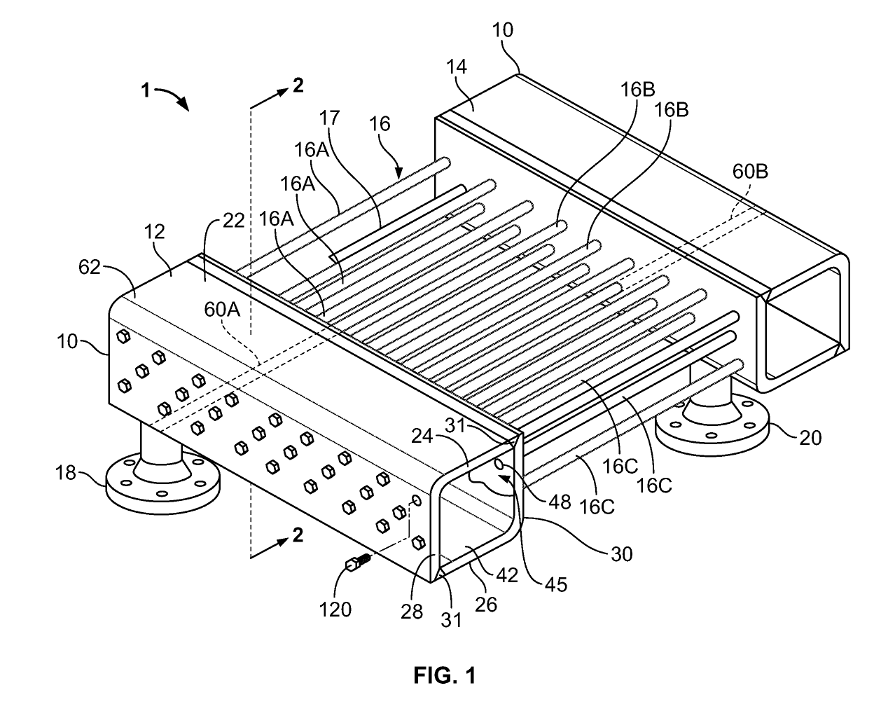

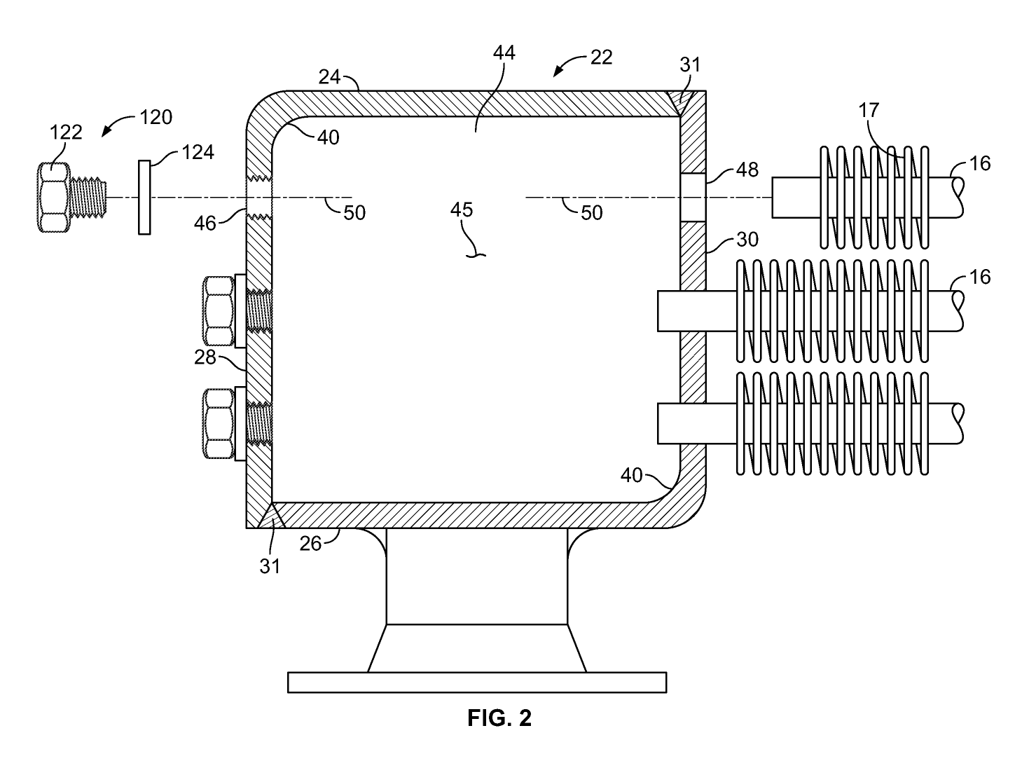

As shown in FIG. 1, a heat exchanger assembly 1 includes two quadrilateral header assemblies or header boxes 10, that is, a first header box 12 and a second header box 14. The header boxes 12, 14 are held in a spaced relation. The heat exchanger assembly 1 further includes a plurality of tubes 16 and two couplings 18, 20. The header boxes 12, 14 are generally symmetrical and, as such, only one header box will be described. The header box 12 includes a hollow body 22 having a generally quadrilateral cross section. The body 22 has a first generally flat side 24 spaced from and generally parallel to a generally flat second side 26. As shown in FIGS. 1 and 2, the first and second sides 24, 26 are generally horizontal. The body 22 also has a third generally flat side 28 spaced from and generally parallel to a generally flat fourth side 30. The third and fourth sides 28, 30 extend generally perpendicular to the first and second sides 24, 26. The third side 28 is integrally coupled to the front side 24 by a rounded corner 40 to form a first header component 27. The fourth side 30 is integrally coupled to the second side 26 by a second rounded corner 40 to form a second header component 29. The first and second sides 24, 26 may be described as a first set of spaced, horizontal sides where one side is an upper side 24 and one side is a lower side 26. The third and fourth sides 28, 30 may be described as a second set of spaced, vertical sides. In the embodiment shown, the horizontal sides 24, 26 are, preferably, between about six and twelve inches in width, and more preferably, about 8 inches in width. The vertical sides 28, 30 are, preferably, between about six and twelve inches in width, and more preferably, about 8 inches in width. However, the sizes of the horizontal sides and vertical sides are not required to be equal and are not required to be in the recited ranges in order to be included within the scope of the invention. The body 22 is formed with two seams 31 as shown in FIG. 2. The seams 31 are welded to join the first header component 27 to the second header component to form the body 22.

The header box 12 also has two ends and a first end plate 42 (FIG. 1) and a second end plate 44 (FIG. 2). The end plates 42, 44 are sized to fit snugly within the perimeter at either end of the body 22. The end plates 42, 44 are coupled to the body 22, preferably by welding. When the end plates 42, 44 are coupled to the body 22, a fluid chamber 45 is formed.

The header box 12 also includes a plurality of plug openings 46 on the third side 28 and tube openings 48 on the fourth side 30. To facilitate use of an expander tool (not shown) for attaching tubes 16 to the tube openings 48 each plug opening 46 is created directly opposite a tube opening 48, and a centerline 50 passing through each plug opening 46 is also a centerline of an opposed tube opening 48. The tubes 16 may also be attached to the tube openings 48 by welding the tube 16 to the header box body 22. In this case, openings 46 may also be created in the header box 22 to facilitate the welding process, but direct alignment of openings 46 and 48 is not necessary.

Each header assembly tube 16 may have one or more fins 17 attached thereto. The fins 17 aid in heat exchange between the fluid within the tubes 16 and the fluid outside the tubes 16. The tubes 16 may also have interior fins (not shown) to assist in heat transfer. Each tube 16 is coupled to both box headers 12, 14 at the location of a tube opening 48. Preferably, each tube 16 is expanded to the box headers 12, 14. Each tube 16 is in fluid communication with the fluid chamber 45. As such, a fluid in the first header fluid chamber 45 may pass through the tubes 16 to the second header fluid chamber (not shown).

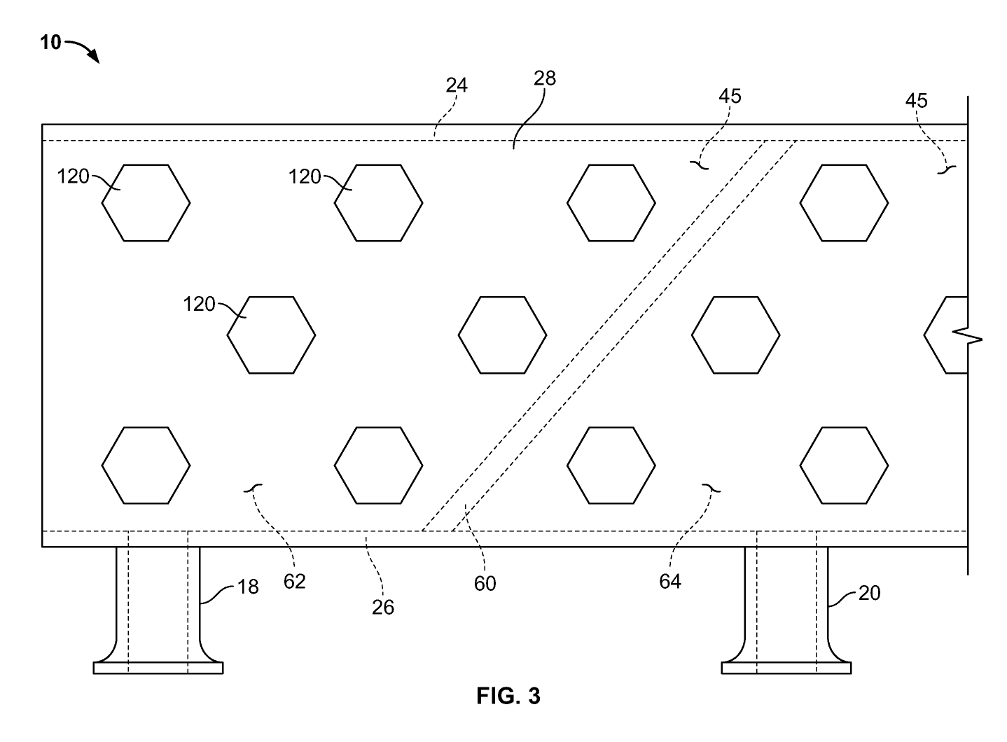

As shown in FIG. 3, pass plates 60 may be disposed within fluid chamber 45. Each pass plate includes a generally planar body. The pass plates 60 divide the fluid chamber 45 into two or more sub-chambers 62, 64. The pass plates 60 are disposed at an angle relative to the vertical axis of the header box 12, 14. Each pass plate 60 passes between, but does not overlap or cover, the tube openings. The pass plates 60 may be welded to the body 22, thereby sealing the first sub-chamber 62 from the second sub-chamber 64.

The header assembly 10 also includes an inlet coupling 18 and an outlet coupling 20. Both the inlet coupling 18 and the outlet coupling 20 are in fluid communication with a header box fluid chamber 45. Depending on the number of pass plates 60 disposed in the fluid chamber 45 of each header box 12, 14, the inlet coupling 18 and the outlet coupling 20 may be disposed on the same header box 12, as shown in FIG. 3, or on different header boxes 12, 14, as shown on FIG. 1.

For example, in operation, describing the header assembly 10 shown in FIG. 1, a hot fluid enters the header assembly 10 through inlet coupling 18, and travels into the first sub-chamber 62 of the fluid chamber 45 of header box 12 located on a first side of the first header box pass plate 60A. The hot fluid then travels through a first portion of the tubes 16A to the second header box 14. As the hot fluid travels through the tubes 16, the fluid is cooled by transferring heat to the air outside of the tubes 16. The second header box pass plate 60B prevents the hot fluid from traveling directly to the outlet coupling 20. Instead, the hot fluid travels through a second portion of the tubes 16B back to the first header box 12 into the second sub-chamber 64 (FIG. 3) of the fluid chamber 45 of first header box 12, located on a second side of the first header box pass plate 60A. Again, as the hot fluid travels through the tubes 16, the fluid is cooled by transferring heat to the air outside of the tubes 16. The fluid then travels through a third portion of the tubes 16C back to the second header box 14, being cooled further by traveling through the tubes 16. The cooled fluid then exits the header assembly 10 through outlet coupling 20.

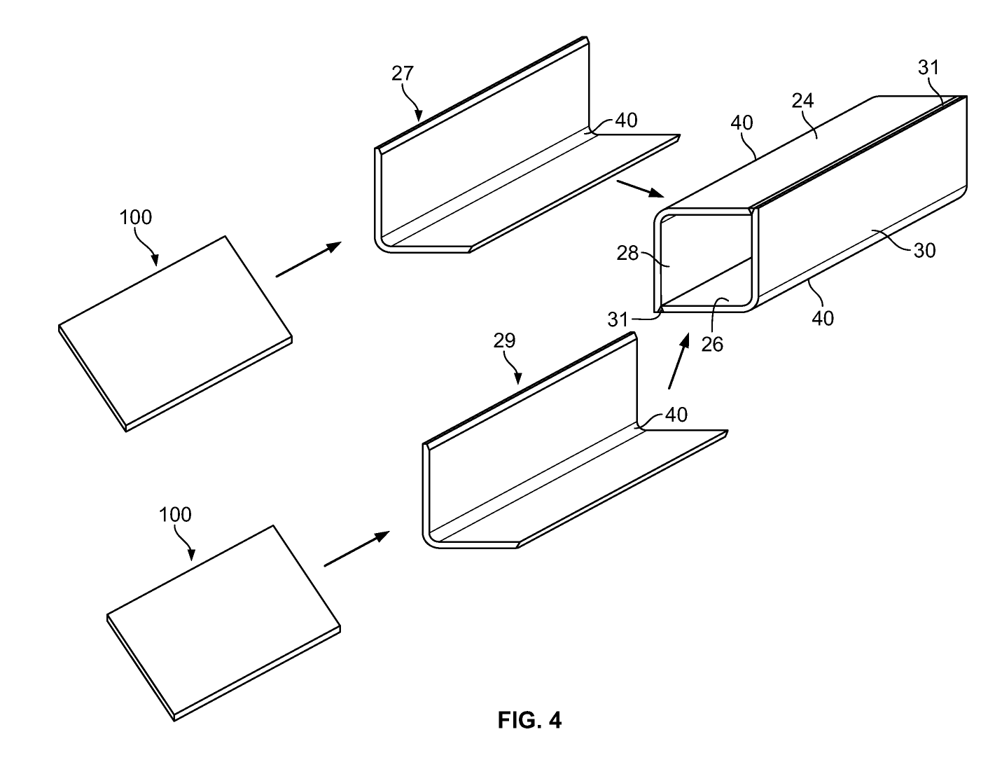

The quadrilateral header box 10 of FIG. 1 may be constructed using two L-shaped header components 27, 29 which are welded together, as shown in FIG. 4. The method of constructing the quadrilateral header assembly 10 begins with forming the header components 27, 29 from flat plates 100. The plates 100 may be mounted on one or more dies (not shown) structured to pass through a forming machine. The plates 100 are then passed through a hydraulic forming machine (not shown), of the type known in the metal forming industry. The forming machine engages and bends the flat plates 100, deforming the flat plates 100 to have an L-shaped configuration. The method used to create the L-shaped header components 27, 29 may be either a cold forming process or a hot forming process.

Once the L-shaped header components 27, 29 are formed, the components are taken off of the dies. The header components 27, 29 have exactly the same profile and are made using the same process and the same forming machine. When assembling the header box 10, two header components are used with one header component 27 rotated 180 degrees from the other header component 29. The header components may then be heat treated to remove any internal stress caused by the forming machine. Mill scale from the heat treating process can be removed by shot blasting the components or by using other commonly known methods of removing mill scale such as buffing or grinding. Thus, what remains are seamless L-shaped header components 27, 29. The sides of the header component have a thickness which is generally between about 0.5 and 1.25 inches, but may be outside the range without departing from the scope of the invention.

The header components 27, 29 may then be cut to the appropriate size for the respective box headers 12, 14. The first and second header components 27, 29 are then welded along seams 31 to form the body 22 of the partially assembled header box 10. In the embodiment shown, the plug openings 46 and a coupling opening are then drilled and/or cut in the header component 27, and the tube openings 48 are then drilled and/or cut in the header component 29. Alternatively, the plug openings 46, tube openings 48 and coupling opening may be drilled prior to the header components 27, 29 being welded along the seams 31. The positioning of the openings on either of the respective header components 27, 29 and respective sides 24, 26, 28, is determined by the desired positioning of the rounded corners 40 when the header box or assembly 10 is assembled. The rounded corners 40 are positioned such that the maximum stress concentrations exerted on the corners of the header assembly 10 by the flow of the fluid in the heat exchanger system are applied to the rounded corners 40 and not to the welded seams 31.

The end plates 42, 44 and any pass plates 60 are welded to the assembled header components 27, 29. The plug openings 46 are then tapped and couplings 18, 20 are then attached, preferably by welding. The partially complete assembly 10 may be heated to relieve any stress caused by the assembly process. The tubes 16 are then attached to two header boxes 12, 14, extending therebetween, at the tube openings 48 by known methods, such as an expansion tool or seal welding. The header assembly 10 is completed by installing plugs 120, preferably a bolt 122 and a gasket 124, in the tapped plug openings 46.

The header assemblies or header boxes 10 shown and described herein have many advantages over the prior art header boxes which are assembled from four individual plates or which are formed from a cylindrical tube. Each header component 27, 29 is made from a metal plate which is easily obtainable. As the header components 27, 29 are made from the same stock material, the amount of different items which must be stored in inventory is reduced. As the plate material is readily available and is often used for other items, the cost of the plate material is relatively low and controlled. In addition, as the machinery needed to bend the header components 27, 29 is known in the industry and is commonly available, the cost of processing the header components is significantly reduced when compared to the cost of process and forming cylindrical tubes into quadrilateral headers.

The use of the header components 27, 29 reduces the labor and cost associated with the manufacture of the header assemblies when compared to the prior art method of welding four individual plates to form the header assembly. By reducing the number of welds from four to two, the labor, fabrication time and expense associated with the assembly of the header assembly are greatly reduced. In addition, long corner welds may fail, either in use or in testing prior to use. In the present invention, as some of the welded corners are replaced by stronger bent or rounded corners 40, the header assemblies 10 can be positioned such that the bent rounded corners 40 are positioned in the corners with the highest stress concentrations, thereby preventing failure of the header assembly 10.

While specific embodiments of the invention have been described in detail, it will be appreciated by those skilled in the art that various modifications and alternatives to those details could be developed in light of the overall teachings of the disclosure. For example, the inlet and outlet couplings 18, 20 are typically on the lower of the two horizontal sides 26. The inlet and outlet couplings 18, 20 may, however, be on any side 24, 26, 28, 30. In addition, many modifications may be made to adapt a particular situation or material to the teachings of the invention without departing from the essential scope thereof. Accordingly, the particular arrangements disclosed are meant to be illustrative only and not limiting as to the scope of invention which is to be given the full breadth of the claims appended and any and all equivalents thereof.

What is claimed is:

1. A method of making a header box for a heat exchanger assembly comprising the following steps:
forming a first header component with a first integral corner;
forming a second header component with a second integral corner;
positioning the first header component proximate the second header component such that both ends of the first header component are positioned proximate respective ends of the second header component;
welding the ends of the first header component to the ends of the second header component to form a header box;
whereby the header box, with the first integral corner and the second integral corner, will withstand the stress concentrations associated with a flow of fluid in the header box.

2. The method of claim 1 wherein, said step of positioning the first header component proximate the second header component includes the step of:
determining the position of the first integral corner and the second integral corner; and
positioning the first integral corner and the second integral corner in a location in which maximum corner stress concentrations associated with the flow of fluid in the header box will occur, thereby reducing stresses associated with the ends of the first header component which are welded to the ends of the second header component.

3. The method of claim 1 including the further step of:
drilling plug openings and tube openings in the first header component and the second header component.

4. The method of claim 3 including the further step of:
welding at least one inlet/outlet coupling to the header box.

5. The method of claim 4 including the further step of:
welding pass plates and end plates to the header box.

6. The method of claim 1 including the further step of:
cutting the first header component and the second header component to an appropriate size for header box.

7. The method of claim 1 including the further steps of:
heat treating the first header component and the second header component; and
shot blasting the first header component and the second header component to remove any mill scale from the heat treating process.

8. A method of making a header box for a heat exchanger assembly comprising the following steps:
forming a pair of identical header components, each of the first and second header components being formed into an L-shape, with each of the first and second headers having a bent corner positioned between two sidewalls, the sidewalls having free ends which extend away from the bent corner;
positioning the first header component proximate the second header component, with the second header component rotated approximately 180 degrees relative to the first header component, such that the free ends of the first header component are positioned proximate the free ends of the second header component;
welding the free ends of the first header component to the free ends of the second header component to form a header box;
whereby the header box, with the first integral corner and the second integral corner, will withstand the stress concentrations associated with a flow of fluid in the header box.

9. The method of claim 8 wherein, said step of positioning the first header component proximate the second header component includes the step of:
determining the position of the corner of the first header component and the corner of the second header component; and
positioning the corner of the first header component and the corner of the second header component in a location in which maximum corner stress concentrations associated with the flow of fluid in the header box will occur, thereby reducing stresses associated with the free ends of the first header component which are welded to the free ends of the second header component.

10. The method of claim 9 including the further step of:
drilling plug openings and tube openings in the first header component and the second header component.

11. The method of claim 10 including the further step of:
welding at least one inlet/outlet coupling to the header box.

12. The method of claim 11 including the further step of:
welding pass plates and end plates to the header box.

13. The method of claim 8 including the further step of:
cutting the first header component and the second header component to an appropriate size for the header box.

14. The method of claim 8 including the further steps of:
heat treating the first header component and the second header component; and
shot blasting the first header component and the second header component to remove any mill scale from the heat treating process.

15. A header box for a heat exchanger assembly, the header box comprising:
a first header component having a first corner portion with a first wall and a second wall extending therefrom, the first and second walls having free ends which extend away from the first corner portion, the first wall extending in a direction which is essentially perpendicular to the second wall;
a second header component having a second corner portion with a third wall and a fourth wall extending therefrom, the third and fourth walls having free ends which extend away from the second corner portion, the third wall extending in a direction which is essentially perpendicular to the fourth wall, the first corner and the second corner being in opposed corners of the header box;
the free ends of the first wall and the third wall cooperate to form a first seam which is welded to maintain the first wall in position relative to the second wall, and the free ends of the second wall and the fourth wall cooperate to form a second seam which is welded to maintain the third wall in position relative to the fourth wall;
whereby the header box, with the first corner portion and the second corner portion, will withstand the stress concentrations associated with a flow of fluid in the header box.

16. The header box of claim 15 wherein the first corner portion and the second corner portion are positioned in a location in which maximum corner stress concentrations associated with the flow of fluid in the header box will occur, thereby reducing stresses associated with the first and second welded seams.

17. The header box of claim 15 wherein, the second side of the first header component has plug openings and the third side of the second header component has tube openings.

18. The header box of claim 15 wherein, an inlet/outlet is coupled to the first wall of the first header component.

19. The header box of claim 18 wherein, a second inlet/outlet is coupled to the first wall of the first header component.

20. The header box of claim 15 wherein, the pass plates and end plates are coupled to the first header component and the second header component.
